(19) United States
(12) Patent Application Publication
(10) Pub. No.: US 2006/0224789 A1
(43) Pub. Date: Oct. 5, 2006

(54) Flash memories and processing systems including the same

(76) Inventors: Hyun-Duk Cho, Suwon-si (KR); Young-Joon Choi, Seongnam-si (KR); Tae-Gyun Kim, Seongnam-si (KR)

Correspondence Address: HARNESS, DICKEY & PIERCE, P.L.C., P.O. BOX 8910, RESTON, VA, 20195, US

(21) Appl. No.: 11/320,874

(22) Filed: Dec. 30, 2005

(30) Foreign Application Priority Data
Apr. 1, 2005 (KR) 2005-27658

(51) Int. Cl. G06F 5/00

(52) U.S. Cl. 710/52

(57) ABSTRACT

A memory may include first and second buffer memories and a memory core. The memory core may include memory blocks each having a plurality of pages and a page buffer for reading data from a selected memory block. A control logic may control the first and second buffer memories and the memory core. The control logic may have a register for storing address and command information of the memory core. The control logic may control the memory core so that data read periods for pages of the selected memory block are carried out according to the stored address and command information. The control logic may control the first and second buffer memories and the memory core so that data in the page buffer may be transferred to the first and/or second buffer memories during the data read periods. The control logic may deactivate an interrupt signal when data in the page buffer is transferred to the first and/or second buffer memory and may activate the interrupt signal when data in the first and/or second buffer memory is transferred to an external storage.

### PRIORITY STATEMENT

This non-provisional U.S. application claims priority under 35 U.S.C. §119 to Korean Patent Application No. 2005-27658 filed on Apr. 1, 2005 in the Korean Intellectual Property Office (KIPO), the entire contents of which are incorporated herein by reference.

### FIELD OF THE INVENTION

Example embodiments of the present invention relate to semiconductor memory devices, for example, non-volatile semiconductor memory devices.

### BACKGROUND

Semiconductor memories may be used in digital logic system designs, such as, computers and/or microprocessor-based applications. Examples of microprocessor-based applications are satellites, consumer electronics, and/or many other electronic devices. Advances in the fabrication of semiconductor memories including, for example, process enhancements and/or technology developments have been made through scaling of memories for higher densities and/or faster speeds. These advances have helped establish performance standards for other digital logic families. Semiconductor memory devices may be characterized as volatile memories (e.g., random access memories (RAMs), etc.) or non-volatile memory devices.

In a volatile memory, such as, a static RAM (SRAM), logic information may be stored by establishing a logic state of a bistable flip-flop. In a volatile memory, such as, a dynamic RAM (DRAM), logic information may be stored by charging a capacitor. In either example, data may be stored and/or read out while power is applied. Data may be lost when the power is turned off and hence, they are volatile memories.

Non-volatile memories, such as mask read only memory (MROM), programmable read only memory (PROM), electrically programmable read only memory (EPROM), electrically erasable read only memory (EEPROM), etc., may store data regardless of whether power is supplied. Conventional non-volatile memory data storage modes may be permanent and/or reprogrammable, depending upon, for example, fabrication technology. Non-volatile memories may be used for program and/or micro-code storage in a wide variety of applications, for example, computer, avionics, telecommunications, consumer electronics industries, etc.

A combination of single-chip volatile and non-volatile memory storage modes may be used in devices such as non-volatile SRAM (nvSRAM). nvSRAM may provide faster, programmable non-volatile memory. Many (e.g., dozens) special memory architectures may improve (e.g., optimize) performance for application-specific tasks by including at least some additional logic circuitry.

Non-volatile memories, such as, MROM, PROM and/or EPROM may not be available (e.g., free) during erase and/or write operations, and it may be more difficult for users to update stored contents. EEPROM may be capable of being erased and/or written electrically. EEPROM may be used in applications, such as, auxiliary memory and/or system programming for continuous updates. A flash EEPROM, for example, may have a higher degree of integration as compared to, for example, a conventional EEPROM. A flash EEPROM may be used in larger auxiliary memories. A NAND-type flash EEPROM (hereinafter, referred to as “NAND-type flash memory”) may have a higher degree of integration than, for example, conventional flash-type EEPROMs (e.g., NOR-type flash EEPROM). The NAND-type flash memory may be used to store larger amounts of data. The NOR-type flash memory may be used to code a smaller amount of data, such as, boot code.

FIG. 1 is a block diagram illustrating an example architecture of conventional memories in a data processing system. A data processing system 1 (e.g., a mobile phone, PDA, laptop computer, etc.) may include a NAND-type flash memory 2, a NOR-type flash memory 3, DRAM 4 and/or a CPU 4. The NAND-type flash memory 2 may store data (e.g., normal data) and the NOR-type flash memory 3 may store program code. The DRAM 4 may function as a working memory. A system using the memory architecture in FIG. 1 may require multiple individual memories for respective applications. This architecture illustrated in FIG. 1 may result in an increase in manufacturing costs. Moreover, since memory controllers 5, 6 and 7 may be required to control the NAND-type flash memory 2, the NOR-type flash memory 3 and the DRAM 4, respectively, the control of a system (e.g., bus architecture) may be more complex.

Conventionally, a unified memory architecture may improve memory architecture. FIG. 2 is a block diagram illustrating an example system 10 with a unified memory architecture. Program code may be stored in an ONE₁₃ NAND-type flash memory, for example, instead of a NOR-type flash memory. The ONE₁₃ NAND-type flash memory 11 may include a data region 11a for storing data and a code region 11b for storing program code. The NOR-type flash memory and its corresponding memory controller may be removed from a system. This may reduce manufacturing costs and/or simplify a bus architecture in a system having the unified memory architecture.

In a system 10 having a unified memory architecture, critical code may reside in DRAM 12 at boot-up. Specific code may be transferred to the DRAM 12 based on a conventional demand-paging function. When utilizing the demand-paging function, data such as the specific code may be transferred to the DRAM 12 from the ONE_NAND-type flash memory 11.

A system with the unified memory architecture illustrated in FIG. 2 may necessitate a more rapid data transfer speed from the ONE₁₃ NAND-type flash memory to the DRAM 12.

### SUMMARY OF THE INVENTION

Example embodiments of the present invention provide a memory (e.g., a ONE₁₃ NAND-type flash memory), which may improve read and/or write speed.

An example embodiment of the present invention provides a memory comprising a first and a second buffer memory. A memory core may include memory blocks each of which may have a plurality of pages and a page buffer for reading data from a selected memory block. A control logic having a register for storing address and command information of the memory core may control the memory core so that data read periods for the selected memory block may be performed based on the stored address and command information. First and second buffer memories and the memory core may also be controlled so that data in the page buffer may be transferred to the first and second buffer memories during the data read periods. An interrupt signal may be deactivated when all, or substantially all, data in the page buffer is transferred to at least one of the first and second buffer memories. The interrupt signal may be activated when all, or substantially all, in at least one of the first and second buffer memory is transferred to an external device.

Another example embodiment of the present invention provides a data processing system including at least one processor, a first memory controllable by a first controller and/or a second memory controllable by a second controller. The second memory may include a first and a second buffer memory. A memory core may include memory blocks each having a plurality of pages and a page buffer for reading data from a selected memory block. A control logic having a register for storing address and command information of the memory core may control the memory core so that data read periods for the selected memory block may be performed based on the stored address and command information. First and second buffer memories and the memory core may be controlled so that data in the page buffer may be transferred to the first and second buffer memories during the data read periods. An interrupt signal may be deactivated when all, or substantially all, data in the page buffer is transferred to at least one of the first and second buffer memories. The interrupt signal may be activated when all, or substantially all, data in at least one of the first and second buffer memory is transferred to the first memory.

Another example embodiment of the present invention provides a control unit. The control unit may have a register for storing address and command information of the memory core may control the memory core so that data read periods for the selected memory block may be performed based on the stored address and command information. The control unit may control first and second buffer memories and the memory core so that data in the page buffer may be transferred to the first and second buffer memories during the data read periods. The control unit may deactivate an interrupt signal when all, or substantially all, data in the page buffer is transferred to at least one of the first and second buffer memories. The control unit may activate the interrupt signal when all, or substantially all, data in at least one of the first and second buffer memory is transferred to an external device.

Anther example embodiment of the present invention provides a method for controlling a memory. The method may include storing address and command information of a memory core. Data read periods for a selected memory block may be performed based on the stored address and command information. Data in a page buffer may be transferred to at least one of the first and second buffer memories during the data read periods. An interrupt signal may be deactivated when all, or substantially all, data in the page buffer is transferred to at least one of the first and second buffer memories, or the interrupt signal may be activated when all, or substantially all, data in at least one of the first and second buffer memory is transferred to an external device.

In example embodiments of the present invention, the address and command information may include at least one of block address information, page address information, page number information and read command information.

In example embodiments of the present invention, the control logic may output a ready signal indicating a fetch time of data from at least one of the first and second buffer memories in response to a chip enable signal.

In example embodiments of the present invention, the chip enable signal may be activated when the interrupt signal is deactivated and may be deactivated when the interrupt signal is activated.

In example embodiments of the present invention, an initial address of data stored in at least one of the first and second buffer memories may be applied to the control logic from the external device when the chip enable signal is activated.

In example embodiments of the present invention, the control logic may further include an address generator circuit for generating a set of addresses to be supplied to at least one of the first and second buffer memories in response to an initial address and a clock signal.

In example embodiments of the present invention, the control logic may determine whether all, or substantially all, data in at least one of the first and second buffer memories has been output to an external device based on an address generated by an address generator circuit.

In example embodiments of the present invention, the control logic may further include an error checking and correction circuit checking and correcting an error of data transferred to at least one of the first and second buffer memories. The error checking and correction circuit may be configured to accumulate error information for each page designated by page address information and page number information at the register.

In example embodiments of the present invention, the external device may check multi-bit error information accumulated at the register and identify a memory block having multi-bit error as a bad block.

In example embodiments of the present invention, when multi-bit error is received in data transferred to at least one of the first and second buffer memories, the error checking and correction circuit may stop the synchronous burst block read operation and inform the external device of the multi-bit error.

In example embodiments of the present invention, the memory may be an ONE₁₃ NAND flash memory.

In example embodiments of the present invention, each of the data read periods may be longer than a period where all, or substantially all, data in at least one of the first and second buffer memory is transferred to the external device.

In example embodiments of the present invention, each of the data read periods may be shorter than a period where all, or substantially all, data in at least one of the first and second buffer memory is transferred to the external device.

In example embodiments of the present invention, the control logic may control the memory core and at least one of the first and second buffer memory so that data in the page buffer may be transferred to at least one of the first and second buffer memory after all, or substantially all, data is transferred to the external device from at least one of the first and second buffer memory.

### BRIEF DESCRIPTION OF THE DRAWINGS

Example embodiments of the present invention will become readily apparent by describing in detail the accompanying drawings in which like reference symbols indicate the same, substantially the same, similar, or substantially the same, components, wherein:

FIG. 1 is a block diagram illustrating an example architecture of conventional memories in a data processing system;

FIG. 2 is a block diagram illustrating a conventional system having a unified memory architecture;

FIG. 3 is a block diagram illustrating a data processing system according to an example embodiment the present invention;

FIG. 4 is a block diagram illustrating a memory according to an example embodiment of the present invention;

FIG. 5 is a block diagram illustrating a memory core according to example embodiment of the present invention;

FIG. 6 is an example timing diagram describing a read operation of a memory core according to an example embodiment of the present invention;

FIGS. 7A and 7B are example diagrams illustrating a data transfer path during a block read operation according to example embodiment of the present invention;

FIG. 8 is a diagram illustrating control signals exchanged between a memory controller and a memory according to an example embodiment of the present invention;

FIG. 9 is an example timing diagram describing a block read operation of a data processing system according to another example embodiment of the present invention;

FIG. 10 is an example timing diagram describing a ready signal according to an example embodiment of the present invention;

FIG. 11 is an example timing diagram describing a block read operation of a data processing system according to another example embodiment of the present invention; and

FIGS. 12A to 12C are example diagrams describing a cache read operation of a memory according to an example embodiment of the present invention.

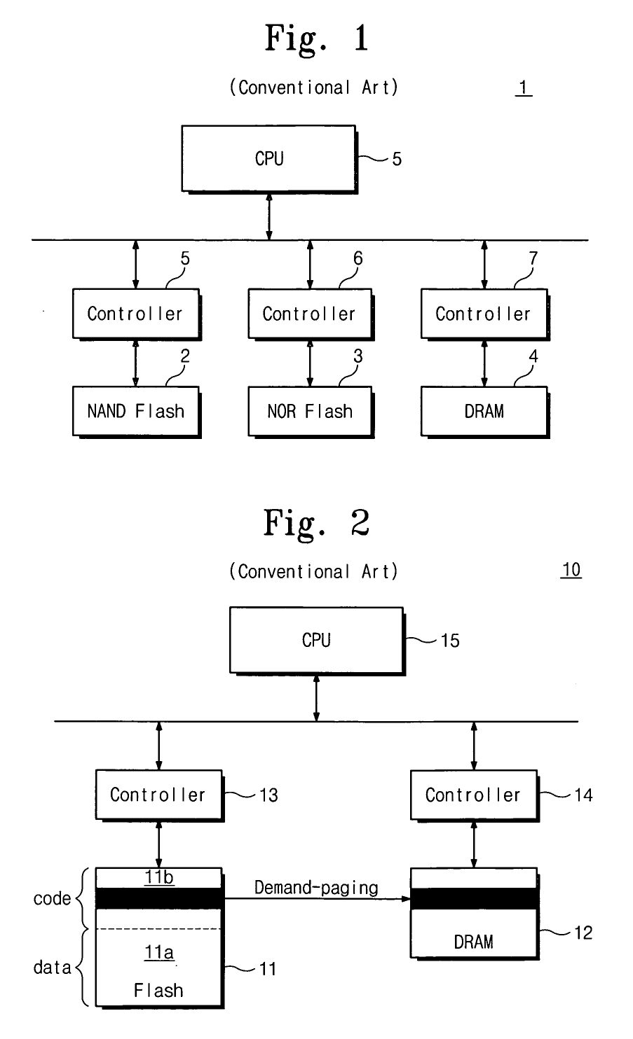

### DETAILED DESCRIPTION OF EXAMPLE EMBODIMENTS OF THE PRESENT INVENTION

Various example embodiments of the present invention will now be described more fully with reference to the accompanying drawings in which some example embodiments of the invention are shown. In the drawings, the thicknesses of layers and regions are exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

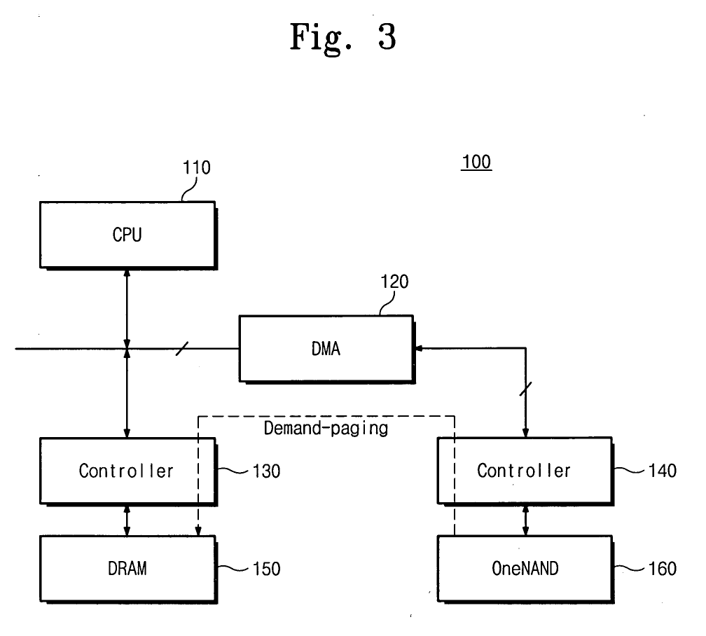

FIG. 3 illustrates a block diagram of a data processing system according to an example embodiment of the present invention.

Referring to FIG. 3, data processing system 100 may include a central processing unit (CPU) 110, a direct memory access (DMA) 120, a first controller 130, a second controller 140, a DRAM 150 and/or a flash memory (e.g., an ONE₁₃ NAND flash memory) 160. The DRAM 150 may be a working memory. The DRAM 150 and the flash memory 160 may be controlled by the first memory controller 130 and the second memory controller 140, respectively. The data processing system 100 may have a unified memory architecture, for example, as illustrated in FIG. 2 and may support a demand-paging function, for example, as described above. The memory 160 may store normal data and/or program code, for example, based on the unified memory architecture. Critical data may reside in the DRAM 150 at boot-up, and specific code may be transferred to the DRAM 150, for example, using the demand-paging function. For example, in the data processing system 100, an amount of data (e.g., program code data and/or general data) may be loaded onto the DRAM 150, for example, with little or no intervention of the CPU 110.

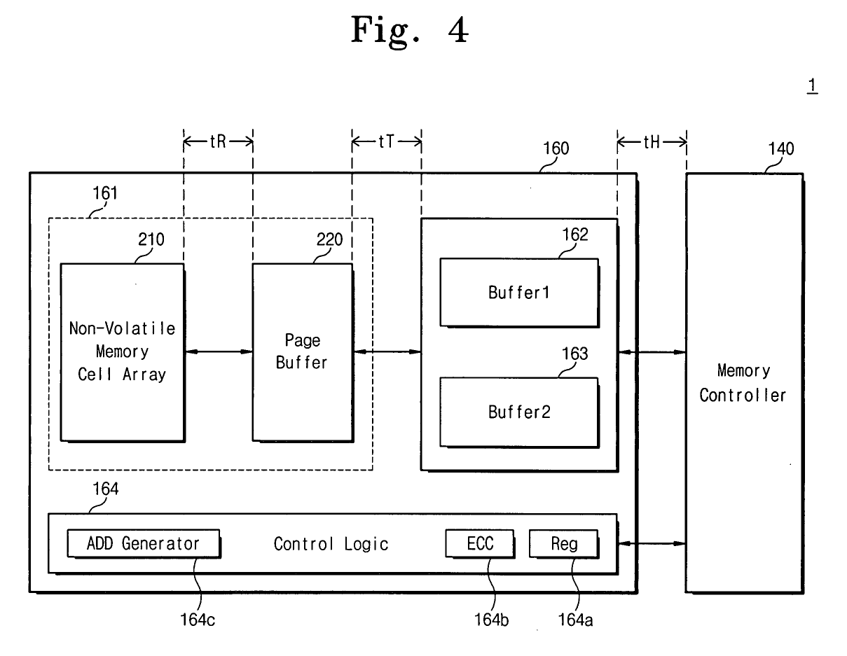

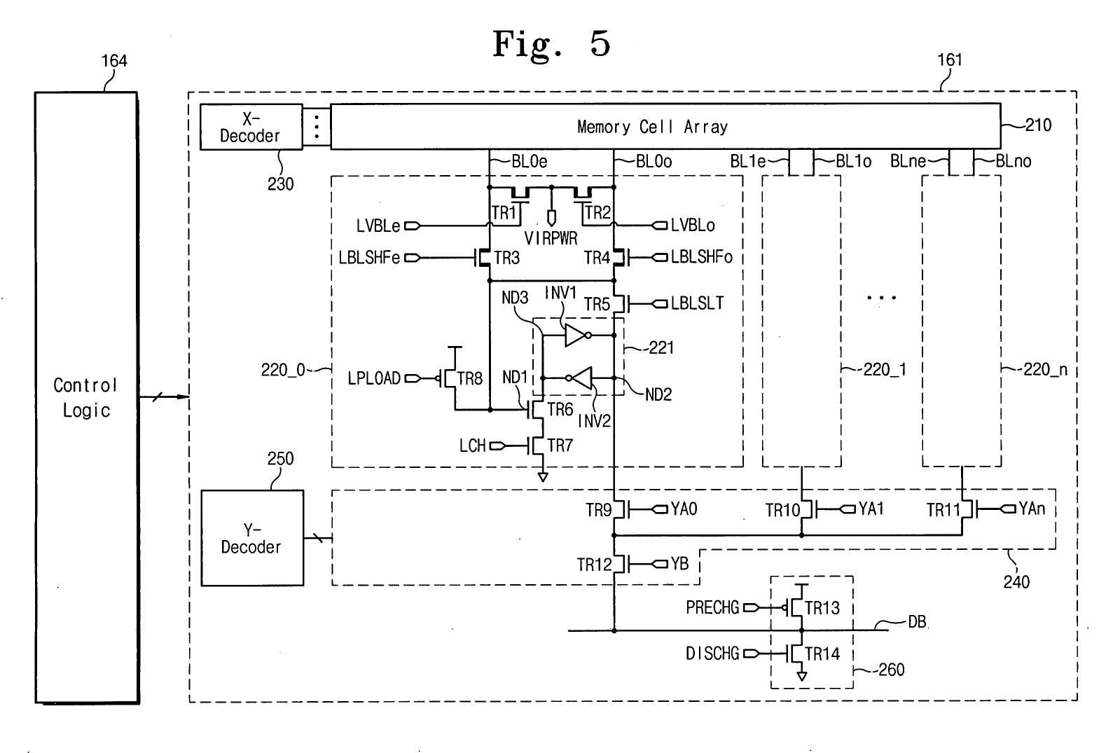

FIG. 4 is a block diagram illustrating a memory, for example, an ONE₁₃ NAND-type flash memory, according to an example embodiment of the present invention.

Referring to FIG. 4, the memory 160 may perform a data read/write operation, for example, according to the control of a memory controller 140. The memory 160 may include a memory core (e.g., a non-volatile memory core) 161, a first buffer memory 162, a second buffer memory 163 and/or a control logic 164. The memory core 161 may include a memory cell array (e.g., non-volatile memory cell array) 210 and/or a page buffer 220. The memory core 161 may be controlled by the control logic 164. Each of the first and second buffer memories 162 and 163 may be controlled by the control logic 164 and the memory controller 140. The first and second buffer memories 162 and 163 may perform read/write operations, for example, individually. Each of the first and second buffer memories 162 and 163 may be used to store (e.g., temporarily store) data from the memory core 161 and/or data to be stored in the memory core 161. In example embodiments of the present invention, the first and second buffer memories 162 and 163 may be SRAMs, DRAMs, or any other suitable memory-type. The first and second buffer memories 162 and 163 may or may not be the same type of memory.

The control logic 164 may include a register 164a, an error checking and correction (ECC) circuit 164b and/or an address generator circuit 164c. The register 164a may be used to store address and/or command information provided from the memory controller 140. Data stored in the register 164a may include a block address, a page address, a page number and/or a read/write/erase command for the memory core 210 (e.g., a non-volatile memory core). An amount of data to be read may be determined by a page address (e.g., as an initial page address) and a page number. In one example, when all, or substantially all, data in a memory block is read, a page address for appointing a first page and a page number indicating the number of pages in a memory block may be stored in the register 164a. The ECC circuit 164b may be used to correct an error (e.g., a 1-bit error), when data is transferred from the memory core 161 to a buffer memory 162 and/or 163. In example embodiments of the present invention, a data transfer operation may be stopped, for example, if a page data with another error (e.g., a multi-bit or 2-bit error) is found upon transfer of data from the memory core 161 to a buffer memory 162 and/or 163. For example, information indicating that a read operation has failed may be stored in the register 164a, for example, under the control of the control logic 164. The memory controller 140 may refer to the stored information in the register 164a, and may mark a memory block having a page in which an error (e.g., a 2-bit error) has occurred, as a bad block.

In another example, an error (e.g., a 2-bit error) may be checked when page data is transferred from the memory core 160 to a buffer memory. The ECC circuit 164b may accumulate error (e.g., 2-bit error) page information and an error (e.g., 2-bit error) number in the register 164a. The accumulated error information may be transferred to the memory controller 140, for example, following data from the buffer memory.

Still referring to FIG. 4, when fetching (e.g., reading) data stored in buffer memory 162 and/or 163, the memory controller 140 may output an initial address of data to be fetched to the memory (e.g., ONE₁₃ NAND-type flash memory) 160. The address generator circuit 164c of the memory 160 may generate (e.g., automatically generate) next addresses, for example, based on the initial address from the memory controller 140. An address generated by the address generator circuit 164c may be applied to buffer memory 162 and/or 163. The control logic 164 may detect whether an address generated by the address generator circuit 164c is a final address. The control logic 164 may control operations of the memory core (e.g., non-volatile memory core) 161 and the buffer memories 162 and/or 163, for example, according to a detection result.

Address and/or command information may be stored in the register 164a, and the control logic 164 may output an amount of data (e.g., all, or substantially all, data or a portion of the data in a memory block) to the memory controller 140 in synchronization with a clock signal CLK. This read operation may be referred to as a synchronous burst block read operation.

Still referring to FIG. 4, a memory core (e.g., non-volatile memory core) 161, according to example embodiments of the present invention, may include a memory cell array 210 and a page buffer 220.

FIG. 5 is a block diagram illustrating a memory core (e.g., a non-volatile memory core) according to an example embodiment of the present invention. The memory cell array 210 may include a number of strings (e.g., NAND strings). Each string may include a string select transistor, a ground select transistor, and/or memory cell transistors connected, for example, in series between the select transistors. Transistors of each string may be controlled by a row decoder circuit 230 according to a mode of operation. Strings may be connected to respective bit lines. In an example embodiment of the present invention, bit lines may be bit line pairs. As shown in FIG. 5, a pair of bit lines may be marked by BL0e and BL0o. Page buffers 220₁₃ 0 to 220₁₃ n may be connected with bit line pairs BL0e and BL0o to BLne and BLno, respectively. The page buffer 220₁₃ 0 may include a latch 221, transistors (e.g., NMOS transistors) TR1-TR7, and a transistor (e.g., PMOS transistor) TR8, which may be connected as shown in FIG. 4. The page buffer 220₁₃ 0 may operate as a register. The page buffer 220₁₃ 0 may store data to be programmed and/or data read out from the array. The transistors TR1 and TR2 may reset the bit lines BLie and BLio (i=0−n) during a bit line reset period of a read operation. In addition, or alternative, the transistors TR1 and TR2 may be used to set unselected bit lines to a ground voltage during periods other than the bit line reset period. The transistors TR3 and TR4 may electrically connect a selected bit line to a node ND1 and/or electrically isolate an unselected bit line from the node ND1. The transistor (e.g., PMOS transistor) TR8 may charge the node ND1. The transistors (e.g., NMOS transistors) TR6 and TR7 may transfer a logic state of the node ND1 to the latch 221. Page buffers 220₁₃ 1 to 220₁₃ n may have the same, or substantially the same configuration and/or function, as page buffer 220₁₃ 0.

A column gate circuit 240 may select a portion of the page buffers 220₁₃ 0 to 220₁₃ n, for example, in response to select signals YA0 to YAn and YB from a column decoder circuit 250. The column gate circuit 240 may electrically connect the selected page buffer(s) to a data bus DB. One data line is shown in FIG. 4; however, the column gate circuit 240 may be configured to connect additional data lines with page buffers.

A charge and discharge circuit 260 may charge the data bus DB with a power supply voltage, for example, in response to a control signal PRECHG. The charge and discharge circuit 260 may discharge the data bus DB to a ground voltage, for example, in response to a control signal DISCHG. The above elements 210 to 260 may be controlled by the control logic 164.

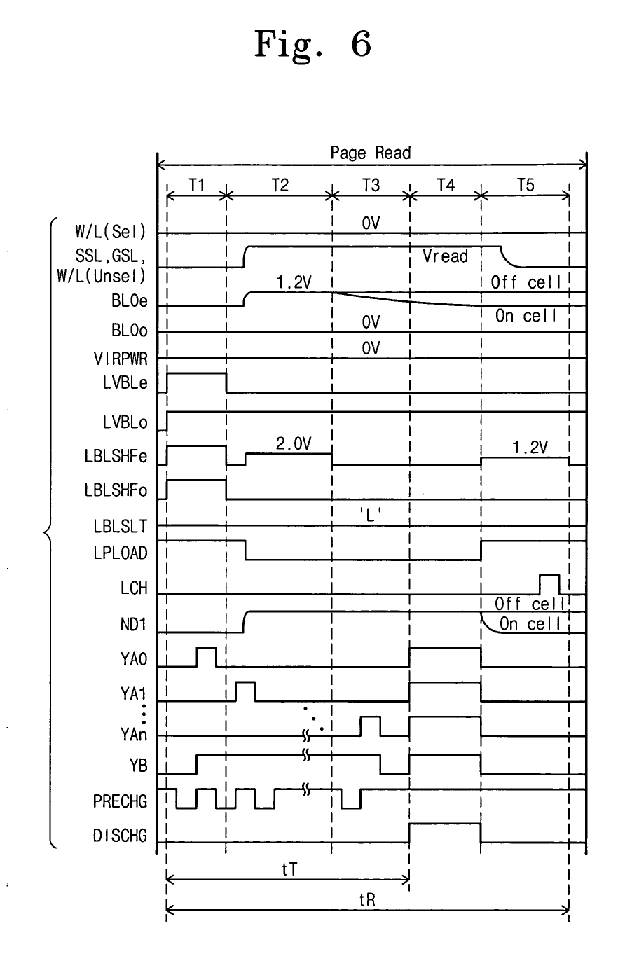

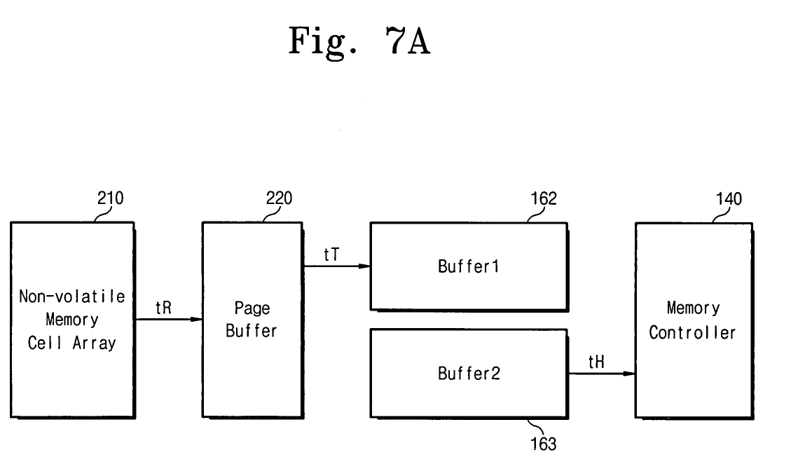

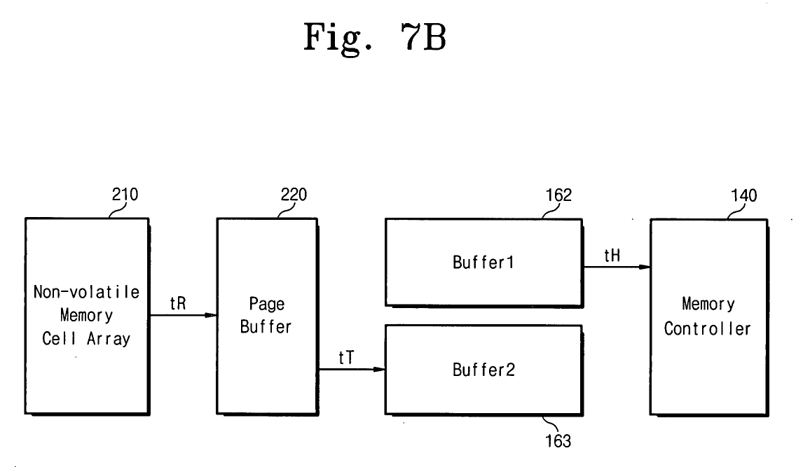

FIG. 6 is an example timing diagram describing a read operation of a memory core (e.g., a non-volatile memory core) according to an example embodiment of the present invention. A read operation of the memory core (e.g., non-volatile memory core) according to an example embodiment of the present invention may be divided into a bit line reset period T1, a bit line pre-charge period T2, a bit line develop period T3, a latch reset period T4 and a sense period T5. Since page buffers 220₁₃ i (where, i=0 to n) may be controlled (e.g., commonly controlled) by the control logic 164, only an operation of a page buffer 220₁₃ 0 will be described.

In one example, as shown in FIG. 5, given that bit line BL0e is selected and bit line BL0o is unselected, a voltage of 0V may be applied to the selected bit line during periods T1 to T5. During periods T2 to T4, a read voltage Vread may be applied to a string select line SSL, a ground select line GSL and unselected word lines.

In this example, during the bit line reset period T1, control signals LVBLe, LVBLo, LBLSHFe, and LBLSHFo may be activated and a control signal LPLOAD may be deactivated. As control signals LVBLe, LVBLo, LBLSHFe and LBLSHFo are activated, bit lines BL0e and BLOo may be electrically connected to a power line VIRPWR having a ground voltage. The bit lines BL0e and BL0o may be reset to a ground voltage. For example, a control signal LBLSLT may be maintained at a lower voltage level during the bit line reset period T1 so that a latch 221 may not be reset.

The bit line BL0e and BL0o may be reset and a selected bit line BL0e may be pre-charged with a pre-charge voltage (e.g., 1.2V) during the bit line pre-charge period T2. As the control signals LVBLe and LBLSHFo go to a lower level, the selected bit line BL0e may be electrically isolated from the power line VIRPWR. An unselected bit line BL0o may be electrically isolated from the node ND1. Since the control signal LVBLo may be maintained at a higher voltage level during the period T2, the unselected bit line BL0o may be electrically connected to the power line VIRPWR having a ground voltage. The control signal LPLOAD may be at a lower voltage level, and a PMOS transistor TR8 may be turned on. Current supplied from the transistor TR8 (e.g., while turned on) may be transferred to the selected bit line BL0e via a NMOS transistor TR3. A voltage of 2.0V is supplied to the LBLSHFe line as illustrated in FIG. 6, and the bit line BL0e may be pre-charged with a voltage of, for example, 2.0V−Vth, where Vth may be a threshold voltage of TR3.

During the bit line develop period T3, a voltage of the selected bit line BL0e may be maintained at the pre-charged voltage or lowered to a ground voltage according to a state (e.g., a program state and/or an erase state) of a selected memory cell. The selected bit line BL0e may be floated. For example, as the control signal LBLSHFe goes to a lower voltage (e.g., ground voltage), the NMOS transistor TR3 may be turned off. This may result in electric isolation of the selected bit line BLOe from the ND1 node.

In one example, if a selected memory cell is in an erase state (or an on state), the pre-charged voltage of the selected bit line may begin to discharge to ground via the selected memory cell in the erase state. In another example, if the selected memory cell has a program state (or an off state), the pre-charged voltage of the selected bit line may be maintained. In this example, the periods T1 to T3 may constitute a period in which cell data stored in a memory cell may be set onto a bit line. This may be referred to as a bit line set period.

After the bit line set period T1 to T3 is completed, the latch 221 in the page buffer 220₁₃ 0 may be reset/initialized during the latch reset period T4. Initializing of the latch 221 may be done, for example, by electrically connecting a node ND2 of a latch 221 to a data bus DB via a column gate circuit 240. As shown in FIG. 6, select signals YA0 to YAn and YB may be activated at the same, or substantially the same, time. A control signal DISCHG may transition to a higher voltage level, and the data bus DB may be grounded through transistor (e.g., NMOS transistor) TR14. The ND2 node of the latch 221 may be electrically connected to the data bus DB via the column gate circuit 240. The data bus DB may be grounded through the transistor (e.g., NMOS transistor) TR14 of the charge and discharge circuit 260. The latch 221 may be reset/initialized.

During the sense period T5, cell data reflected on the selected bit line BL0e may be stored in the latch 221. The control signal LPLOAD may be deactivated and a voltage of 1.2V may be applied to the LBLSHFe line. In this example, if a memory cell in an on state (e.g., an erase state) is connected to the selected bit line BLOe, a voltage of the ND1 node may be discharged via the on cell. Alternatively, if a memory cell in an off state (e.g., a program state) is connected to the selected bit line BLOe, the voltage at the ND1 node may be maintained. This may be a result of transistor (e.g., NMOS transistor) TR3 (e.g., Vg=1.2, Vs=1.2V, Vd=Vcc) being shut off. If a memory cell is in an on state, a transistor (e.g., NMOS transistor) TR6 may be turned off. If a memory cell is in an off state, the transistor TR6 may be turned on in case of the latter.

If a memory cell in an on state (e.g., an erase state) is connected to the selected bit line BLOe, a control signal LCH may be pulsed, and an ND3 node of the latch 221 may be grounded through transistors (e.g., NMOS transistors) TR6 and TR7. If a memory cell in an off state (e.g., a program state) is connected to the selected bit line BLOe, the ND3 node may be in an initialized state (e.g., at a higher voltage level).

In example embodiments of the present invention during periods T1 to T3 of periods T1-T5, a set of data in the latches 221 of the page buffers 220₁₃ 0 to 220₁₃ n may be transferred to the data bus DB through the column gate circuit 240. In one example, a data transfer unit may vary according to the data input/output organization. For example, data in the latches 221 of the page buffers 20₁₃ 0 to 220₁₃ n may be transferred to the data bus DB during the bit line set period T1 to T3. This may be done, for example, by activating (e.g., sequentially activating) the select signals YA0 to YAn. Select signals YA0 to YAn may be set by setting the select signal YB to a higher voltage level. The data bus DB may be charged with a power supply voltage, for example, between activation periods of the select signals YA0 to YAn. Charging of the data bus DB with the power supply voltage may be made by activating the transistor (e.g., PMOS transistor) TR13 of the charge and discharge circuit 260 for at least one or, for example, each and/or every charge interval.

In example embodiments of the present invention, data stored in the page buffers 220₁₃ 0 to 220₁₃ n may be transferred to the data bus DB during periods T1 to T3. Data transferred to the data bus DB may be output to one of buffer memories 162 and 163. Since page data stored in a page (or row) of memory cells is output to a buffer memory during the periods T1 to T3 of another page (or row), time needed for a read operation (e.g., a continuous read operation) may be reduced.

In example embodiments of the present invention, page data output during a first read operation may be garbage data. Page data output during a second read operation may be page data sensed during the first read operation.

In an example read operation of a flash memory according to example embodiments of the present invention, a time tR may indicate a time needed to transfer page data from the memory cell array 210 to the page buffer 220. This may be referred to as a read operation time. A time tT may indicate a time needed to transfer page data from the non-volatile memory core 161 (or from the page buffer 220) to at least one of the buffer memories 162 and 163. This may be referred to as a buffer transfer time. A time tH may indicate a time needed to transfer page data from buffer memory 162 and/or 163 to a memory controller 140. This may be referred to as a host transfer time.

In this example, page data may be transferred from a non-volatile memory core 161 to a buffer memory 162 and/or 163 according to the control of the control logic 164 during a bit line set period T1 to T3 (or a read operation time tR). Page data in a buffer memory 162 and/or 163 may be transferred to a memory controller 140 during all, or substantially all, periods T1 to T5 of a read operation (or during the read operation time tR). This read operation may be referred to as a cache read operation. Similarly, page data may be transferred from the non-volatile memory core 161 to the buffer memory 162 and/or 163 during the periods T1 to T3 (tT). Page data in the buffer memory 162 and/or 163 may be transferred to the memory controller 140 during all, or substantially all, periods T1 to T5 of a read operation (or during the read operation time tR) (tH). In an example read operation (e.g., continuous read operation), the host transfer time tH for transferring page data from a buffer memory to the memory controller 140 may be hidden (e.g., embedded) within the read operation time tR. In another example, the read operation time tR may be hidden (e.g., embedded) within the host transfer time tH.

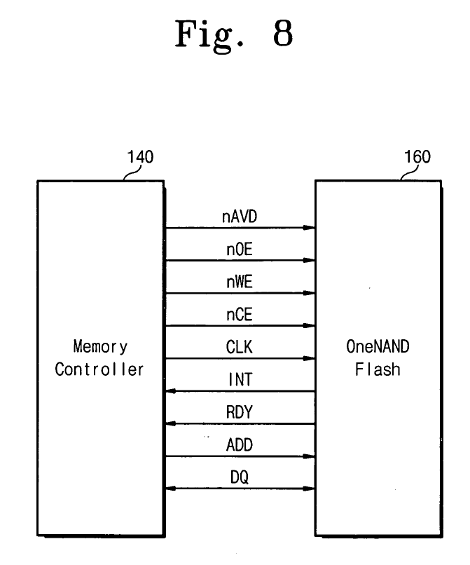

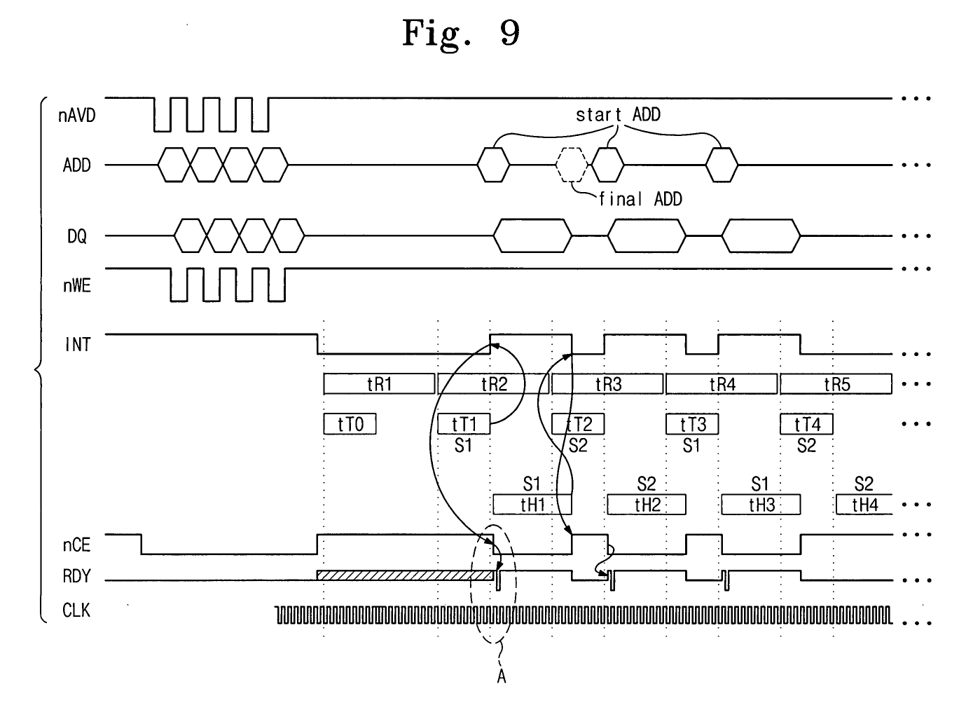

FIG. 8 shows example control signals, which may be exchanged between a memory controller and a flash memory according to example embodiments of the present invention. FIG. 9 is an example timing diagram describing a synchronous burst block read operation according to an example embodiment the present invention.

In a data processing system according to example embodiments of the present invention, address and/or command information may be stored in a register 164a of control logic 164. The address and/or command information may be used to read out data from a flash memory 160. Once address and command information are stored in the register 164a, data read out from a non-volatile memory core 161 may be stored in the first and/or second buffer memories 162 and 163 according to the control of the control logic 164. The CPU 110 may not intervene. When the memory controller 140 fetches (e.g., reads, retrieves, etc.) data stored in the first and/or second buffer memories 162 and 163, an initial address and/or a read command of a buffer memory may be provided to the control logic 164. Data may be transferred (e.g., automatically transferred) to the memory controller 140 from a buffer memory 162 and/or 163, for example, without additional addresses.

In an example where data (e.g., program code) required by the CPU 110 is not present in the DRAM 150, the data may be loaded into the DRAM 150 from the flash memory 160 under the control of the DMA 120. This data may be loaded using demand-paging; however, any suitable method or technique for loading the data may be used. The CPU 110 may request the required data via the DMA 120. The CPU 110 may not intervene until the required data is loaded onto the DRAM 150. Once a data request is made, the DMA 120 may control the memory controller 140 so that the data may be read out.

Referring to FIG. 9, in order to perform a synchronous burst block read operation, the memory controller 140 may transition an nCE signal go to a lower voltage level, and may output (e.g., sequentially output) a block address BA, a page address PA, page number data # OF PAGE, and/or a command CMD to the flash memory 160. The block address BA, the page address PA, the page number data # OF PAGE and/or the command CMD from the memory controller 140 may be stored in the register 164a of the flash memory 160. The register 164a may be set up with address and/or command data, and the control logic 164 may activate an interrupt signal INT. The synchronous burst block read operation may be controlled by the control logic 164. Block and page addresses stored in the register 164a may be output to the non-volatile memory core 161. The control logic 164 may control a cache read operation of the non-volatile memory core 161.

One (e.g., 0th memory block) of memory blocks may be selected by a row decoder 230. Any one (e.g., 0th page) of the pages in the selected memory block may be selected by the row decoder 230, for example, if even-numbered bit lines BLie of bit line pairs BLie and BLio (where, i=0 to n) are selected. All, or substantially all, bit lines BLie and BLio may be reset to a ground voltage within a bit line reset period T1. The selected bit lines BLie may be pre-charged to a given pre-charge voltage within a bit line pre-charge period T2. During a bit line develop period T3, cell data of memory cells in the selected page may be reflected in the selected bit lines BLie. After a bit line set-up period T1 to T3, latches 221 of page buffers 220₁₃ 0 to 220₁₃ n may be reset by connecting the latches 221 to a data bus DB through a column gate circuit 240 during a latch reset period T4. Data values on the selected bit lines may be transferred to corresponding latches 221 within a sense period T5. During periods T1 to T3, data values stored in the latches 221 may be transferred to the data bus DB through the column gate circuit 240. Data transferred on the data bus DB may be stored in a second buffer memory 163 under the control of control logic 164.

Data values stored in latches 221 during periods T1 to T3 may be transferred to a selected buffer memory during a buffer transfer time tTO. If a read operation for the 0th page is completed (or, in another example, if a data read time tR1 elapses), the control logic 164 may control the non-volatile memory core 161 to read data of a next page. As illustrated in FIG. 9, data of the next page may be read out (e.g., automatically read out) without re-setting of a register 164a. For example, an interrupt signal INT may be maintained at a lower voltage level. Similarly, during periods T1 to T3 for the next page, data values (e.g., 0th page data read out during a tR1 period) stored in the latches 221 may be transferred to the data bus DB through the column gate circuit 240. Data transferred on the data bus DB may be stored in a first buffer memory 162 (e.g., S1 of FIG. 9) under the control of the control logic 164.

Once data is loaded in the first buffer memory 162 and/or 163 is completed (e.g., after a time tT1), the control logic 164 may deactivate the interrupt signal INT, for example, by setting the interrupt signal INT to a higher voltage level. In example embodiments, the control logic 164 may count a clock signal (e.g., a number of transitions of an nRE signal) needed to output page data and may determine whether data loading to the first buffer memory 162 and/or 163 from the non-volatile memory core 161 has been completed. A memory controller 140 may make a signal nCE transition from a higher voltage level to a lower voltage level, for example, in response to a lower voltage level to higher voltage level transition of the interrupt signal INT. The memory controller 140 may output an initial address of the first buffer memory 162 and/or 163 to the flash memory 160 in synchronization with a higher voltage level to lower voltage level transition of the signal nCE.

The control logic 164 may transition a signal RDY to a higher voltage level in response to a higher voltage level to lower voltage level transition of the nCE signal. An address generator circuit 164c of the control logic 164 may increase (e.g., sequentially increase) the received initial address in synchronization with a clock signal CLK. The generated addresses may be applied to the first buffer memory 162. The first buffer memory 162 may output data in response to received addresses. The memory controller 140 may fetch data from the first buffer memory 162, which may be output in synchronization with the clock signal CLK, at a higher-level transition of the RDY signal. For example, the memory controller 140 may fetch data with reference to the RDY signal provided from the flash memory 160.

Continuously, for example, the control logic 164 may determine whether all, or substantially all, data in the first memory 162 and/or 163 may be transferred to the memory controller 140, and may control the interrupt signal INT accordingly. For example, the control logic 164 may determine whether an address generated by the address generator circuit 164c is a final address of the first buffer memory 162 and/or 163. If an address generated by the address generator circuit 164c is not a final address of the first buffer memory 162, the control logic 164 may deactivate the interrupt signal INT. This may indicate that all, or substantially all, data of the first buffer memory 162 has not been transferred to the memory controller 140. If an address generated by the address generator circuit 164c is a final address of the first buffer memory 162, the control logic 164 may activate the interrupt signal INT. This may indicate that all, or substantially all, data in the first buffer memory 162 has been transferred to the memory controller 140.

For example, data stored in the first buffer memory 162 may be transferred to the memory controller 140 during a tH1 period. If all, or substantially all, data in the first buffer memory 162 has been transferred to the memory controller 140, the control logic 164 may activate the interrupt signal INT by transitioning from a higher voltage level to a lower voltage level. The memory controller 140 may deactivate the nCE signal in response to an activation of the interrupt signal INT. The RDY signal may transition to a higher-impedance state at a lower voltage level to higher voltage level transition of the nCE signal.

After buffer transfer time tT2 when data read within a tR2 period is transferred to the second buffer memory 163, the interrupt signal INT may be deactivated. When the interrupt signal INT is inactive, the memory controller 140 may transition the nCE signal from a higher voltage level to a lower voltage level. The RDY signal may transition from a higher-impedance state to a higher voltage level according to a lower voltage level transition of the nCE signal. Data stored in the second buffer memory 163 may be transferred to the memory controller 140 in synchronization with the clock signal CLK in the same, or substantially the same, manner as described above with regard to the first buffer memory 162.

Data of remaining pages of the selected memory block may be transferred to the memory controller 140 in the same, or substantially the same, manner as described above.

In FIG. 9, when the nCE signal is inactive, a system bus may be used by the CPU, and bus use efficiency may be improved.

As shown in FIG. 9, the register 164a may be set to read a given amount of data (e.g., all, or substantially all, data stored in any memory block), and a synchronous burst block read operation and/or a cache read operation of the non-volatile memory core 160 may be performed (e.g., automatically carried out) under the control of the control logic 164. The synchronous burst block read operation and/or a cache read operation of the non-volatile memory core 160 may be performed, for example, without re-setting of the register 164a and/or without intervention of the CPU 110. For example, the memory controller 140 may fetch (e.g., read, retrieve, etc.) a desired amount of data, for example, with reference to the RDY signal. This may indicate that data is stored in a buffer memory, without any intervention after transferring address and/or command information to the flash memory 160. All, or substantially all, of the synchronous burst block read operation may be performed by the flash memory 160, and burden on the CPU 110 may be reduced.

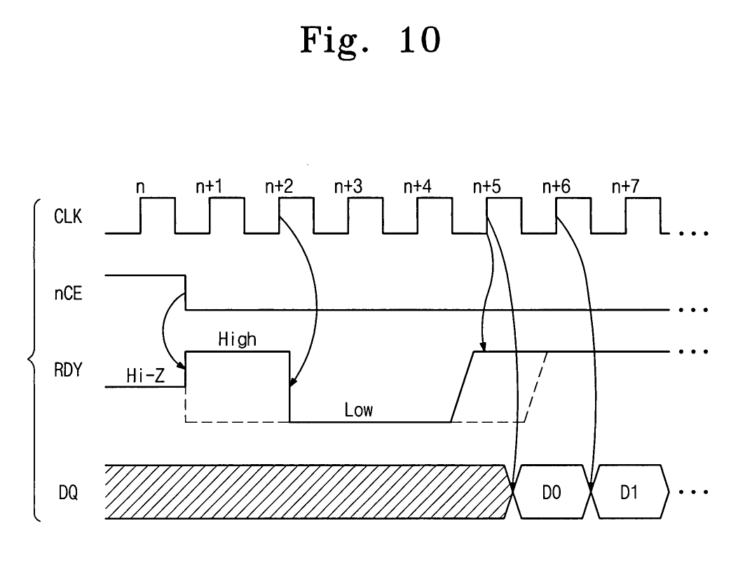

FIG. 10 is an example timing diagram describing the variation of an RDY signal according to an example embodiment of the present invention.

Referring to FIG. 10, when an nCE signal transitions to a lower voltage level, the RDY signal may be changed from a higher-impedance state to a higher voltage level. The RDY signal transitions to a lower voltage level, following one cycle of a clock signal CLK (e.g., at (n+2)th cycle of the clock signal CLK). In another example, the RDY signal may transition to a lower voltage level when the nCE signal transitions to a lower voltage level as marked by a dotted line. The RDY signal may transition to a higher voltage level, for example, after a given time following a lower voltage level transition. A memory controller 140 may detect a higher voltage level of the RDY signal at a given point in time (e.g., (n+5)th or (n+6)th cycle) after the nCE signal has transitioned to a lower voltage level. If the higher voltage level of the RDY signal is detected at the given point in time, the memory controller 140 may fetch (e.g., read, retrieve, etc.) data output in synchronization with the clock signal CLK. The RDY signal may be used as an indication signal for indicating a point in time when the memory controller 140 fetches data from a buffer memory.

In an example where a host transfer time tH is longer than a data read time tR, and before all, or substantially all, data stored in a first and/or second buffer memory 162 and/or 163 may be transferred to a memory controller 140, new data from a non-volatile memory core 161 may be written in the first and/or second buffer memories 162 and/or 63.

In order to reduce the likelihood of error or memory faults, the flash memory 160 may control a data read operation (tR) and/or a buffer transfer operation (tT).

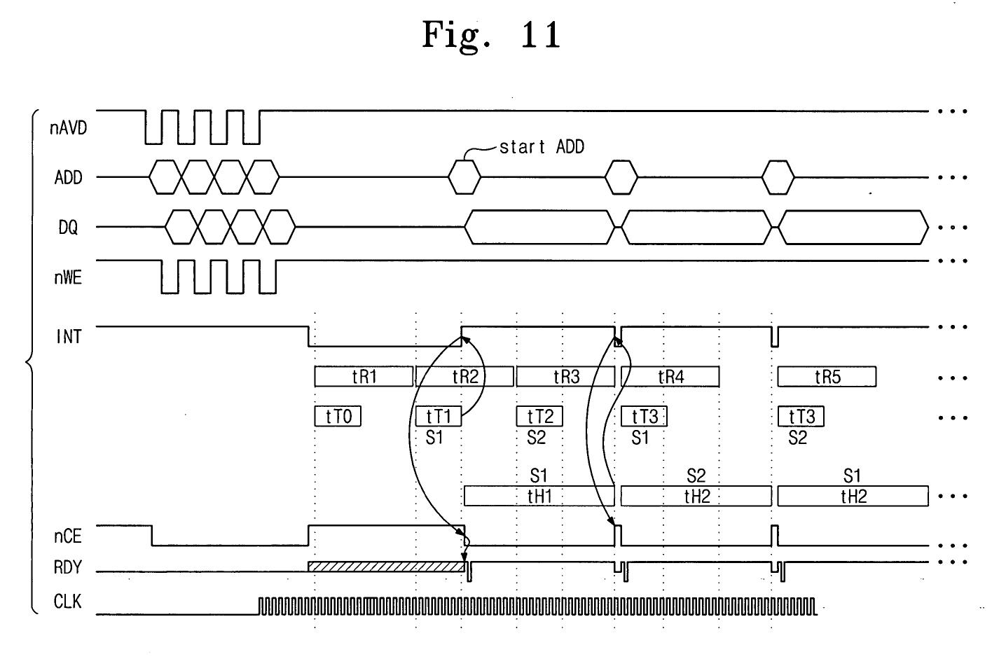

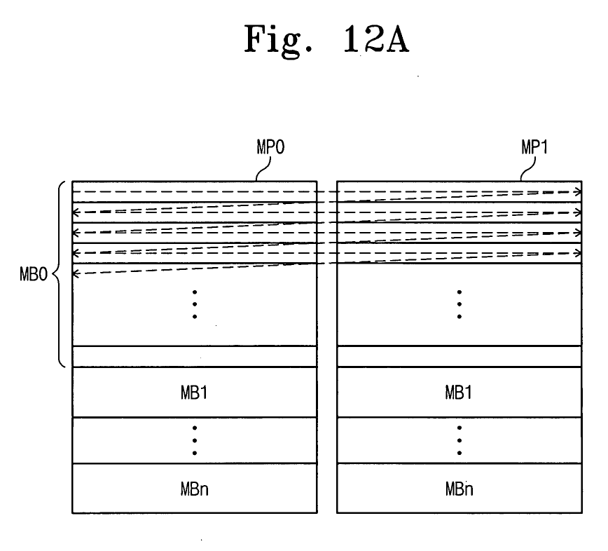

For example, as shown in FIG. 11, control logic 164 may control the non-volatile memory core 161 and/or the buffer memories 162 and/or 163 so that a data read operation (tR4) and a buffer transfer operation (tT3) may be carried out after a host transfer time (tH1) elapses.

In an example where all, or substantially all, data stored in the first buffer memory 162 (e.g., S1 of FIG. 11) is not transferred to the memory controller 140, if the data read operation tR4 and the buffer transfer operation tT3 are performed, new data may be written in the first buffer memory 162. In this example, data (e.g., page data read at a tR3 period) of a next page to be stored in the first buffer memory 162 may be transferred to the first buffer memory 162 after all, or substantially all, previous page data (e.g., page data read at a tR1 period) has been transferred to the memory controller 140 from the first buffer memory 162. Similarly, a buffer transfer operation for the second buffer memory 163 may be performed in the same, or substantially the same, manner as the first buffer memory 162.

In a synchronous burst block read operation according to example embodiments of the present invention, whether all, or substantially all, data stored in a buffer memory has been transferred to the memory controller 140, may be determined with reference to an address generated from an address generator circuit 164c. However, it will be understood that any suitable method for determining whether all, or substantially all, data stored in a buffer memory has been transferred may be used.

For example, the memory controller 140 may provide an initial address to the flash memory 160 to fetch data stored in the first buffer memory 162. The initial address may be increased (e.g., sequentially increased) by the address generator circuit 164c in synchronization with the clock signal CLK. Before all, or substantially all, data may be transferred, the memory controller 140 may deactivate the nCE signal. As the nCE signal is deactivated (e.g., transitioned to a higher voltage level), an operation of the address generator circuit 164c may be stopped although the clock signal CLK may still be supplied. The memory controller 140 may provide a final address to the flash memory 160 when a final address may be generated by the address generator circuit 164c (e.g., as marked by a dotted line in FIG. 9). The control logic 164 may control next data read and/or buffer transfer operations based on the address may be provided. The following synchronous burst block read operation and/or cache read operation may be performed in the same, or substantially the same, manner.

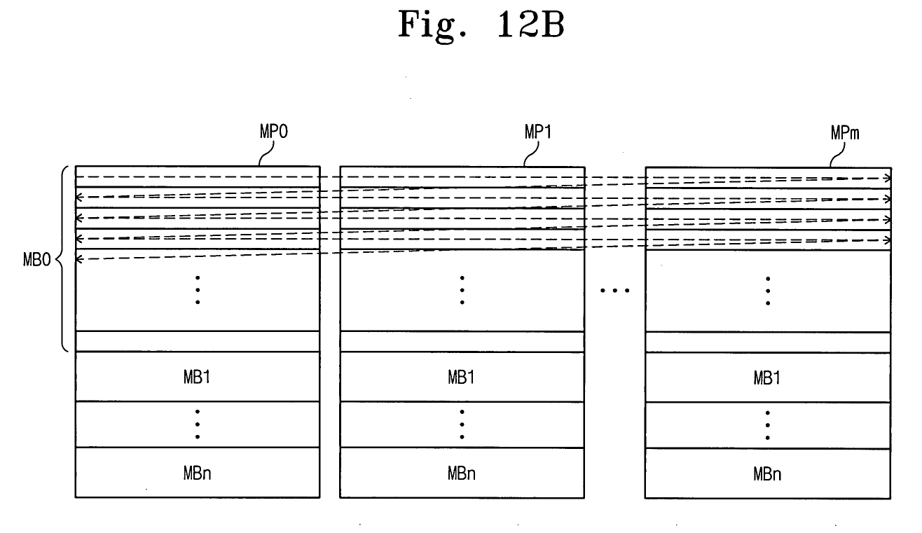

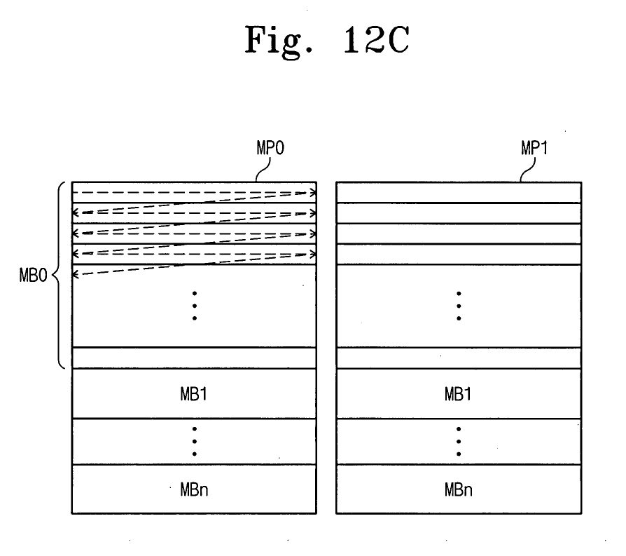

One or more example embodiments of the present invention may support a multi-page program method in which pages in the same row and/or existing at different memory plans may be programmed, for example, simultaneously. Pages programmed by the multi-page program method may be read in the same, or substantially the same, order as programmed. For example, as illustrated in FIG. 12A, given that pages in the same row of two memory plans MP0 and MP1 are programmed at the same, or substantially the same, time, pages in the same row may be read in a manner marked by a dotted line as illustrated in FIG. 12A. Data read may be transferred to one or more buffer memories.

Similarly, as illustrated in FIG. 12B, although three or more memory types may be used, pages programmed by the multi-page program method may be read in the same, or substantially the same, manner as described in FIG. 12A. If a program operation is not performed in the multi-page program method, as illustrated in FIG. 12C, pages in any memory type may be read (e.g., sequentially).

In example embodiments of the present invention, the memory controller 140 may communicate with the flash memory 160 in a demultiplexing manner in which address and data lines may be separated. However, it will be understood that example embodiments of the present invention are not limited to this disclosure. For example, the memory controller 140 and the flash memory 160 may be configured to communicate in a multiplexing manner where address and data lines may be commonly used.

In example embodiments of the present invention, controlling of a synchronous burst block read operation by a flash memory may reduce burden of the CPU and/or increase the speed at which data may be loaded into a memory or memories.

Although example embodiments have been described with regard to specific voltage levels for activating and/or deactivating signals, gates, etc., it will be understood that any suitable voltage level and/or logic signal may be used interchangeably.

Although example embodiments of the present invention have been described with regard to NMOS and/or PMOS transistors, it will be understood that any suitable transistor (e.g., NMOS, PMOS, CMOS, etc.) may be used interchangeably.

Although example embodiments have been described with regard to specific memories (e.g., PROM, EPROM, DRAM, SRAM, etc.), it will be understood that any suitable memory may be utilized.

Example embodiments of the present invention have been described. However, it is understood example embodiments of the present invention are not limited to the disclosed example embodiments. On the contrary, the present specification is intended to cover various modifications and similar arrangements. The scope of the claims, therefore, should be accorded the broadest interpretation so as to encompass all such modifications and similar arrangements.

What is claimed is:

1. A memory comprising:
a first and a second buffer memory;
a memory core including memory blocks each having a plurality of pages and a page buffer for reading data from a selected memory block; and
a control logic having a register for storing address and command information of the memory core, controlling the memory core so that data read periods for the selected memory block are performed based on the stored address and command information, controlling first and second buffer memories and the memory core so that data in the page buffer is transferred to the first and second buffer memories during the data read periods, deactivating an interrupt signal when all data in the page buffer is transferred to at least one of the first and second buffer memories, and activating the interrupt signal when all data in at least one of the first and second buffer memory is transferred to an external device.

2. The memory of claim 1, wherein the address and command information includes at least one of block address information, page address information, page number information and read command information.

3. The memory of claim 1, wherein the control logic outputs a ready signal indicating a fetch time of data from at least one of the first and second buffer memories in response to a chip enable signal.

4. The memory of claim 3, wherein the chip enable signal is activated when the interrupt signal is deactivated and is deactivated when the interrupt signal is activated.

5. The memory of claim 3, wherein an initial address of data stored in at least one of the first and second buffer memories is applied to the control logic from the external device when the chip enable signal is activated.

6. The memory of claim 1, wherein the control logic further includes an address generator circuit for generating a set of addresses to be supplied to at least one of the first and second buffer memories in response to an initial address and a clock signal.

7. The memory of claim 1, wherein the control logic determines whether all data in at least one of the first and second buffer memories has been output to an external device based on an address generated by an address generator circuit.

8. The memory of claim 1, wherein the control logic further includes an error checking and correction circuit checking and correcting an error of data transferred to at least one of the first and second buffer memories.

9. The memory of claim 8, wherein the error checking and correction circuit is configured to accumulate error information for each page designated by page address information and page number information at the register.

10. The memory of claim 9, wherein the external device checks multi-bit error information accumulated at the register and identifies a memory block having multi-bit error as a bad block.

11. The memory of claim 8, wherein when multi-bit error is received in data transferred to at least one of the first and second buffer memories, the error checking and correction circuit stops the synchronous burst block read operation and informs the external device of the multi-bit error.

12. The memory of claim 1, wherein the memory is an ONE₁₃ NAND flash memory.

13. The memory of claim 1, wherein each of the data read periods is longer than a period where all data in at least one of the first and second buffer memory is transferred to the external device.

14. The memory of claim 1, wherein each of the data read periods is shorter than a period where all data in at least one of the first and second buffer memory is transferred to the external device.

15. The memory of claim 14, wherein the control logic controls the memory core and at least one of the first and second buffer memory so that data in the page buffer is transferred to at least one of the first and second buffer memory after all data is transferred to the external device from at least one of the first and second buffer memory.

16. A data processing system, comprising:
at least one processor;
a first memory controllable by a first controller; and
a second memory controllable by a second controller, the second memory including,
a first and a second buffer memory;
a memory core including memory blocks each having a plurality of pages and a page buffer for reading data from a selected memory block; and
a control logic having a register for storing address and command information of the memory core, controlling the memory core so that data read periods for the selected memory block are performed based on the stored address and command information, controlling first and second buffer memories and the memory core so that data in the page buffer is transferred to the first and second buffer memories during the data read periods, deactivating an interrupt signal when all data in the page buffer is transferred to at least one of the first and second buffer memories, and activating the interrupt signal when all data in at least one of the first and second buffer memory is transferred to the first memory.

17. A control unit, comprising:
a register for storing address and command information of a memory core for a read operation; wherein
the control unit controls the memory core so that data read periods for a selected memory block are performed based on the stored address and command information, controls first and second buffer memories and the memory core so that data in a page buffer is transferred to the first and second buffer memories during the data read periods, deactivates an interrupt signal when all data in the page buffer is transferred to at least one of the first and second buffer memories, and activates the interrupt signal when all data in at least one of the first and second buffer memory is transferred to an external device.

18. A method for controlling a memory, the method comprising:
storing address and command information of a memory core;
performing data read periods for a selected memory block based on the stored address and command information;
transferring data in a page buffer to at least one of the first and second buffer memories during the data read periods; and
deactivating an interrupt signal when all data in the page buffer is transferred to at least one of the first and second buffer memories or activating the interrupt signal when all data in at least one of the first and second buffer memory is transferred to an external device.

19. A data processing system comprising:
at least one processor; and
the memory of claim 1.

20. A memory comprising:
first and second buffer memories;
a memory core including memory blocks each having a plurality of pages and a page buffer for reading data from a selected memory block; and
a control unit; wherein,
the control unit is the control unit of claim 17.

21. A data processing system comprising:
at least one processor;
at least a first memory controllable by a first controller; and
a second memory controllable by a second controller; wherein
the second memory is the memory of claim 20.

22. A control unit for performing the method of claim 18.

23. A memory comprising:
first and second buffer memories;
a memory core including memory blocks each having a plurality of pages and a page buffer for reading data from a selected memory block; and
a control unit; wherein,
the control unit is the control unit of claim 22.

24. A data processing system comprising:
at least one processor;
at least a first memory controllable by a first controller; and
a second memory controllable by a second controller; wherein
the second memory is the memory of claim 23.
